(19) United States
(12) Patent Application Publication
(10) Pub. No.: US 2025/0102797 A1
(43) Pub. Date: Mar. 27, 2025

(54) Head-Up Display with Eye-Tracking

(71) Applicant: Envisics Ltd, Milton Keynes (GB)

(72) Inventors: Timothy Smeeton, Milton Keynes (GB); Alexander Cole, Milton Keynes (GB)

(21) Appl. No.: 18/887,995

(22) Filed: Sep. 17, 2024

(30) Foreign Application Priority Data
Sep. 26, 2023 (GB) 2314735.8

(51) Int. Cl. G02B 27/01; B60K 35/235

(52) U.S. Cl. CPC G02B 27/0101; B60K 35/235; B60K 2360/741

(57) ABSTRACT

There is provided a display system. The display system comprises a head-up display unit arranged in cooperation with the optical combiner to define: a first optical path between the head-up display unit to a first viewing region of the display system; and a second optical path between the head-up display to a second viewing region of the display system. The display system further comprises an optical combiner arranged to direct first light on the first optical path and direct second light on the second optical path. The first optical path intersects a first portion of the optical combiner. The second optical path intersects a second portion of the optical combiner. An infra-red reflectivity of the second portion is greater than that of the first portion.

### CROSS-REFERENCE TO RELATED APPLICATIONS

The present application claims priority under 35 U.S.C. § 119 to UK Patent Application GB 2314735.8 titled “Head-Up Display With Eye-Tracking,” filed on September 26, and currently pending. The entire contents of GB 2314735.8 are incorporated by reference herein for all purposes.

### FIELD

The present disclosure relates to a display or projection system with user-tracking for augmented reality and a method of integrating a user-tracking system with a display or projection system. Embodiments relate to a head-up display with an integrated eye-tracking system. Other embodiments relate to head-up display system in a vehicle having a windscreen, wherein the head-up display comprises an integrated eye-tracking system directed at a blackout region of the vehicle windscreen.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In an aspect there is provided a display system. The display system comprises a head-up display unit. The head-up display unit is arranged in cooperation with the optical combiner to define: a first optical path between the head-up display unit to a first viewing region of the display system; and a second optical path between the head-up display to a second viewing region of the display system. The display system further comprises an optical combiner arranged to direct first light on the first optical path and direct second light on the second optical path. The first optical path intersects a first portion of the optical combiner. The second optical path intersects a second portion of the optical combiner. The second portion is part of a blackout region of the optical combiner. An infra-red reflectivity of the second portion may be greater than that of the first portion.

The optical combiner may be a windscreen such as a vehicle windscreen. The optical combiner comprises a blackout region (sometimes called a “frit” or “frit band” when used by the automotive industry) which is a non-transmissive or black band or frame around the perimeter of the optical combiner. Notably, the inventors have identified that this region of the optical combiner is advantageous for providing an optical path from the head-up display package to the eye-box. For example, in some embodiments, the head-up display package includes an eye-tracking camera, operating on infra-red wavelengths (e.g. sensitive to 950 +/−50 nm such as 940 nm), that uses (e.g. points towards) a portion of the blackout of the optical combiner. The blackout region is a visually non-intrusive area of the optical combiner. The blackout region also corresponds to the part of the combiner where the curvature is relatively low which means that optical distortion and/or aberration are at a minimum. This improves the accuracy of any measurements made using the second optical path such as eye-tracking measurements.

There is therefore provided a head-up display unit or package that provides at least two optical channels. A first optical channel provides picture content to a viewer. A second optical channel provides at least one measurement of the viewer such as eye position and/or gaze direction. In some embodiments, the second channel also provides illumination of the viewer with, for example, infra-red light. In some embodiments, the second channel may be described as being bidirectional because it is used to both deliver infra-red source light from the head-up display package that illuminates the viewer (or “eye-box” region) and receive a light return signal comprising infra-red light that has been reflected or scattered light from the viewer. In some embodiments, a picture generating unit is used to process the picture content in real-time for augmented reality. In some embodiments, the picture generating unit comprises a compute chip such as a field programmable gate array or application specific integrated circuit. The compute chip may calculate holograms of the picture in real-time. Significant advantages are achieved by locating a user-tracking system within the head-up display package. For example, in embodiments, user-tracking data obtained from the user-tracking system is routed directly to the compute chip of the picture generating unit without having to interface with other sub-systems such as other sub-systems of the vehicle. This can help achieve the low latency required for real-time augmented reality in a dynamic environment such as motorway driving. A further advantage is that an additional location in the vehicle is not needed to locate a user-tracking device such as a camera.

In some embodiments, the second portion comprises an infra-red reflective component or “patch”. The infra-red patch may be applied to the blackout at the bottom of the optical combiner. The patch is not intrusive and can be low cost. The positioning of the patch in accordance with this disclosure avoids the need for a reflective film on the windscreen which adds complexity and cost. Importantly, it also avoids the need to comprehensively correct for the complex shape of the windscreen—and any optical aberrations-which otherwise affect the accuracy of measurements made using the second optical path. Further advantageously, there will not be interference from sunlight.

In some embodiments, the second portion comprises a thermal insulation layer between the reflective component and the blackout component. In use of the display device, the blackout component may get relatively hot. This may be because of illumination of the blackout component by the sun. The blackout component may absorb said sunlight and increase in temperature. The thermal insulation layer may advantageously reduce the background infra-red radiation at the reflector.

In some embodiments, the second portion is disposed below the first portion. For example, the second portion may be disposed adjacent a lower boundary or border of the optical combiner.

In some embodiments, the first light comprises visible light corresponding to an image visible from the first viewing region. The first light may be spatially-modulated in accordance with a hologram of the image.

In some embodiments, the second light comprises infra-red light for illuminating the second viewing region.

The first light may be output by a light engine of the head-up display unit. The light engine may be a picture generating unit or a hologram generating unit. The second light may be output by an infra-red light source of the head-up display.

In some embodiments, the head-up display further comprises an infra-red detector arranged to capture second light reflected in the second region. The second light reflected in the second region may be reflected by a user of the head-up display. The infra-red detector may perform user-tracking, such as eye-tracking or gaze-tracking. The user (or eye or gaze) tracking may be based on the captured second light reflected in the second region.

In some embodiments, the second optical path corresponds to a field of view of the infra-red detector. In some embodiments, the first optical path corresponds to a field of view of the light engine.

The first viewing region may be an eye-box of the display system. The second viewing region may be a viewer monitoring region of the display system. In some embodiments, the first viewing region and second viewing region are the same region of space or at least partially overlapping regions of space. In some embodiments, the first viewing region is a sub-region of the second viewing region, or vice versa. Each viewing region may be an area of two-dimensional space or volume of three-dimensional space.

In some embodiments, the second viewing region includes reference positions of a vehicle housing the display system. The second portion may comprise reference markers. The reference positions of the vehicle or the reference markers of the second portion may be usable for calibration of the display system such as positional or rotational calibration of the infra-red detector.

In some embodiments, the optical combiner has curvature and the infra-red reflective component has curvature. In some embodiments, the optical combiner may have curvature and the infra-red reflective component may be planar.

Features and advantages described in relation to one aspect may be applicable to other aspects.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander;

FIG. 6 shows an example of a head-up display package comprising a waveguide and an eye-tracker;

FIG. 7 shows a schematic top view of a head-up display package comprising an improved eye-tracker according to the present disclosure;

FIG. 8 shows a schematic cut-away side view of the head-up display package located in the dashboard of a vehicle comprising an optical combiner;

FIG. 9 shows a schematic forward view from the point of view of a driver in the vehicle of FIG. 8; and

FIG. 10 shows a close-up schematic view of a portion of the optical combiner of FIGS. 8 and 9.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship-for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

Conventional Optical Configuration for Holographic Projection

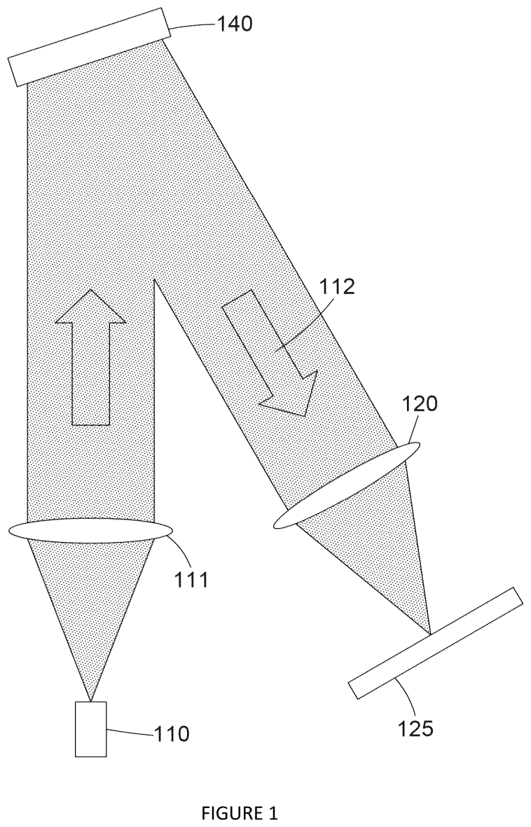

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View and Eye-Box Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

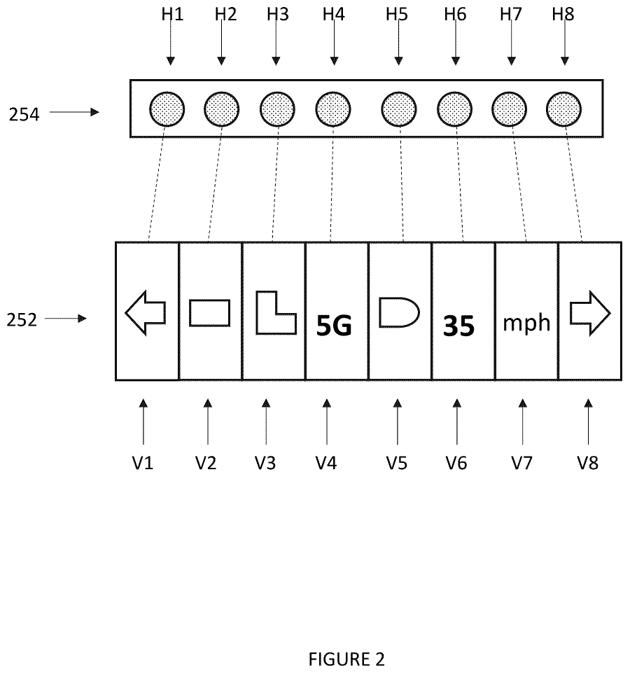

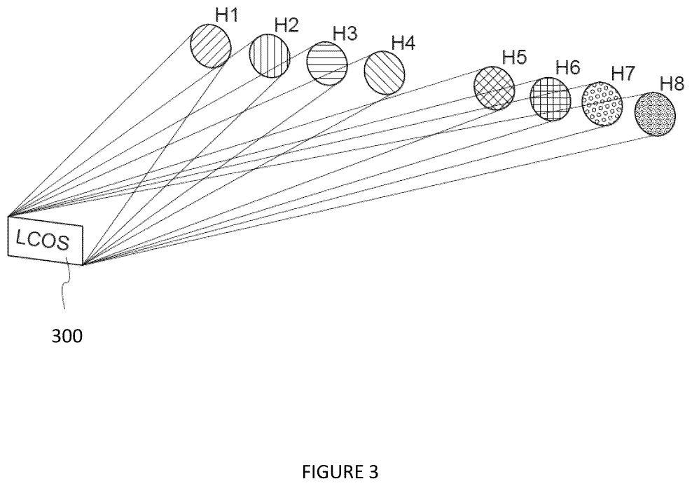

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

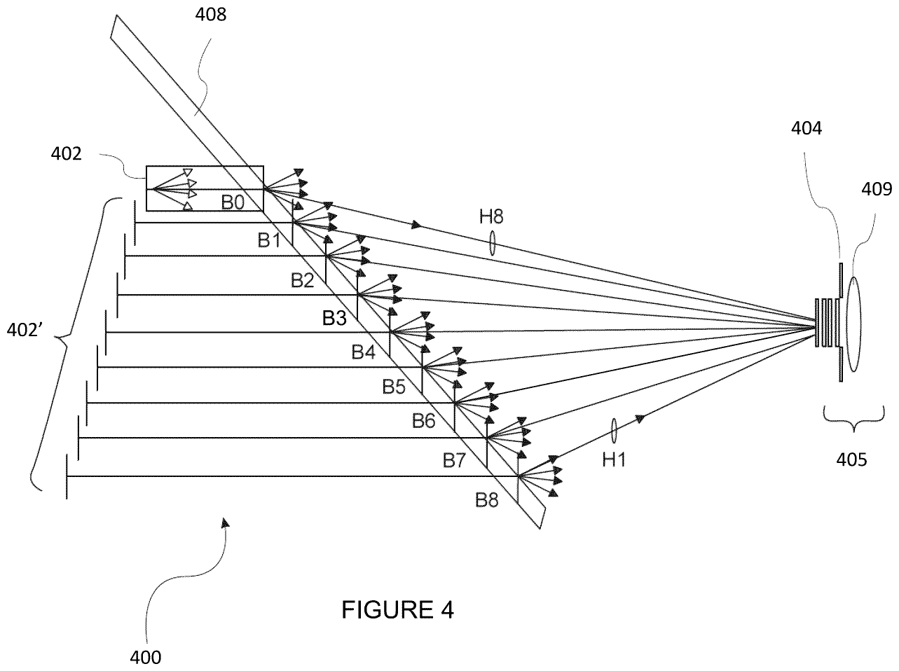

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

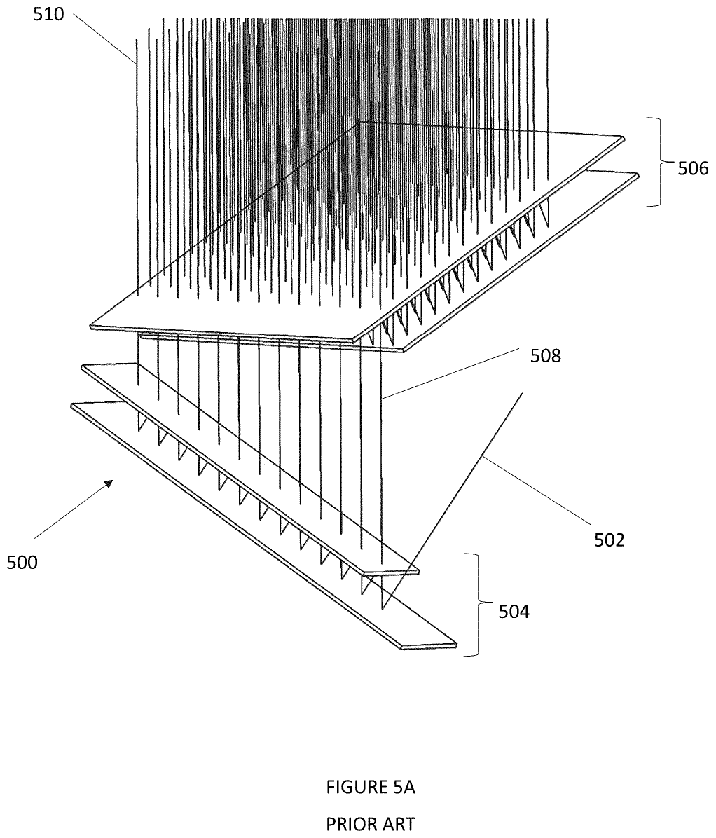

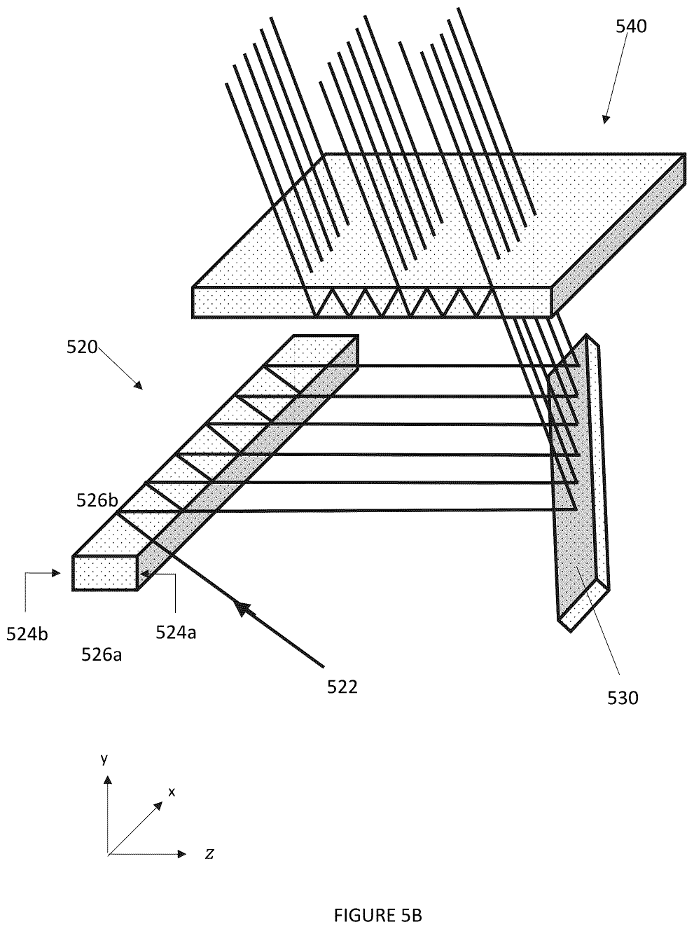

The waveguide 408 forms a plurality of replicas of the hologram, at the respective “bounce” points B1 to B8 along its length, corresponding to the direction of pupil expansion. As shown in FIG. 5, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Eye-Tracking

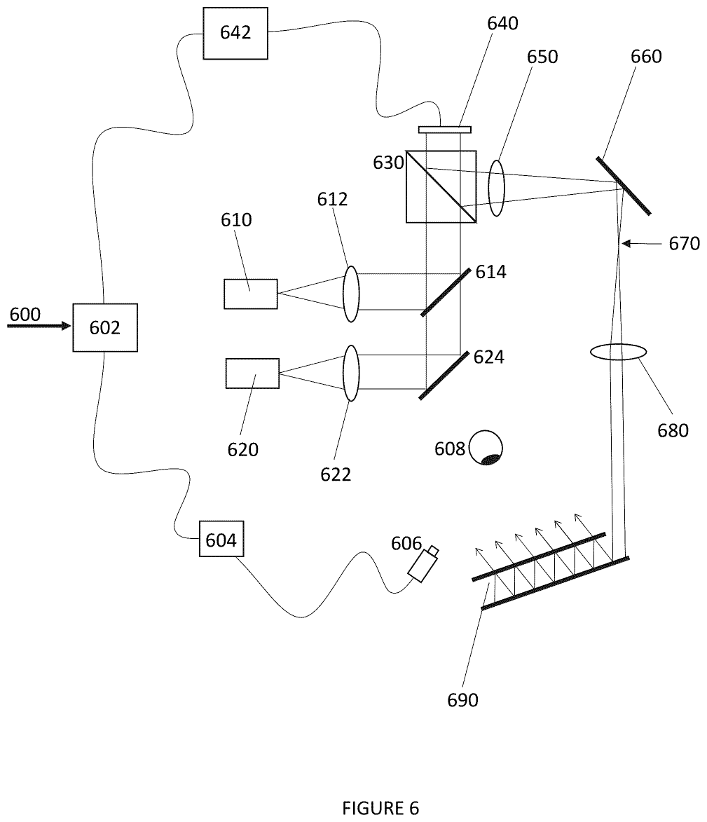

Some holographic display devices include user tracking such as eye-tracking, using an eye-tracking device. FIG. 6 shows an example of such a holographic display device comprising a waveguide forming a waveguide pupil expander and further comprising an eye-tracking device. Such holographic display devices may be arranged to receive an input from the user/eye tracking device. The holographic display device may be arranged to determine a current position of the user (or the eye or eyes of a user) based on the input, for example. The holographic display device may be arranged to calculate, recalculate or modify a hologram to be displayed by the holographic display device based on this determined position. An example of this is described in relation to FIG. 6.

In the example of FIG. 6, the holographic display device comprises a picture Generating unit arranged to form a first picture (also called “first image”) and a second picture (also called “second image”). In this example, a first single colour channel (also called “first display channel”) is arranged to form the first picture and comprises a first light source 610, a first collimating lens 612 and a first dichroic mirror 614. First dichroic mirror 614 is arranged to reflect light of a first wavelength along a common optical path so as to illuminate a spatial light modulator (SLM) 640. The first wavelength of light corresponds to the first display channel of a first colour (e.g. red). A second single colour channel (also called “second display channel”) is arranged to form the second picture and comprises a second light source 620, a second collimating lens 622 and a second mirror 624. Second mirror 624 is arranged to reflect light of a second wavelength along the common optical path so as to illuminate the SLM 640. The second wavelength of light corresponds to the second single colour channel of a second colour (e.g. green). In other embodiments, the picture generating unit may comprises a third single colour/display channel (equivalent to the first and second channels) arranged to form a third picture, wherein the third colour channel corresponds to a wavelength of light of a third colour (e.g. blue). In the illustrated embodiment, SLM 640 comprises a single array of light modulating pixels (e.g. LCOS) that is illuminated by light of both the first and second wavelengths. In other embodiments, SLM 640 may comprise separate arrays of light modulating pixels that are illuminated by light of the respective first and second wavelengths.

Holographic display device further comprises a holographic controller 602 arranged to control the picture generating unit, specifically the light output by picture generating unit as described herein. First spatially modulated light of the first colour corresponding to the first picture is output by SLM 640 to form a first single colour image (e.g. red image). A first single colour computer-generated hologram is calculated by a holographic controller 602 and encoded on SLM 640, for example by a display driver 642. The SLM 640 displays the first hologram and is illuminated by light of the first colour from the first colour/display channel to form a first holographic reconstruction at an intermediate plane 670 which may also be referred to as a replay plane. Similarly, second spatially modulated light of the second colour corresponding to the second picture is output by SLM 640 to form a second single colour image (e.g. green image) at the intermediate 670. A second single colour computer-generated hologram is encoded on SLM 640 by holographic controller 602. The SLM 640 displays the second hologram and is illuminated by light of the second colour from the second colour/display channel to form a second holographic reconstruction at the replay plane. In the illustrated arrangement, a beam splitter cube 630 is arranged to separate input light to SLM 640 and spatially modulated light output by SLM 640. A Fourier lens 650 and mirror 660 are provided in the optical path of the output spatially modulated light to the intermediate plane 670. Thus, a composite colour reconstruction may be formed at the intermediate plane 670. A second lens 680 is arranged to project the first and second pictures formed on the light receiving surface 672 to an input port of a pupil expander in the form of a waveguide 690. A viewer 608 may receive spatially modulated light from the expanded eye box—the “viewing window”—formed by waveguide 690. Waveguide 690 comprises an optically transparent medium separated by first and second reflective surfaces as described above with reference to FIG. 4. Thus, holographic display device has a “direct view” configuration—that is the viewer directly receives spatially modulated light that has been modulated in accordance with a picture, rather than image light.

The holographic display device further comprises a viewer-tracking system comprising an eye tracking camera 606 and an eye tracking controller 604. As known in the art, the eye tracking camera is arranged to capture images of the eye(s) of the viewer for tracking the eye position, and thus the viewing position within the viewing window. Eye tracking controller 604 provides feedback to holographic controller 602 indicating the current viewing position. In example implementations, holographic controller 602 is arranged to dynamically adjust a brightness of the first and second images according to the current viewing position. In particular, a brightness of the first and second images may be adjusted to compensate for a difference in the reflectivity of light of the first and second wavelengths of the first (partially) reflective surface of the slab waveguide at the propagation distance corresponding to the current viewing position. In some examples, in a given viewing position, different content may be received from different replicas formed by the waveguide. Given the differences in reflectivity, and the difference in viewing distance, the brightness of the content from different replicas may vary. Without correction, this may result in the brightness of the holographic reconstruction being unintentionally non-uniform and the non-uniformity of brightness may vary as a user moves around a viewing window of the system. It may be said that the holographic controller 602 is arranged to adjust a brightness of the first and/or second images (or one or more portions of the first and/or second images) as seen at the current viewing position to compensate for the difference in reflectivity response of the second reflective surface to light of the respective first and second wavelengths. This maintains the perceived colour balance at different viewing positions within the viewing window. Calibration data may be used to fine-tune the brightness of one or more of the single colour images in real-time in order to maintain colour balance. The calibration data may be obtained by a calibration process comprising measuring the relative brightness of each single colour image at a plurality of different viewing positions within the viewing window.

In some implementations, the holographic controller 602 may be arranged to adjust the relative brightness of the first and second pictures according to the current viewing position by adjusting one or more drive signals (e.g. provided by a light source controller) to the first light source 610 and second light source 620. A drive signal to a light source controls the power to the light source and thus the optical power of the output light. In other implementations, the holographic controller 602 may be arranged to adjust the relative brightness of the first and second pictures by adjusting one or more of the first and second computer-generated holograms. For example, the quantisation scheme used for calculation of the first and/or second hologram may be changed in accordance with the current viewing position. The quantisation scheme may be changed to reduce the light modulation range within which allowable light modulation levels are distributed, which may change the intensity of pixels of the calculated hologram.

In other examples, the user/eye-tracking can alternatively or additionally be used for calculating the hologram so as to reduce or eliminate the risk of ghost images being formed. So-called ghost images may be formed because a user, in a particular viewing position, may receive the same content from more than one replica formed by the waveguide. Because the propagation path differs for the different replicas, ghosts (i.e. secondary copies of the content, generally having a lower intensity) can be formed. This can adversely affect the viewing experience. User or eye-tracking can be used to determine a current viewing position and based on that, modify the hologram to reduce ghosts and/or control a control device (as described previously) to prevent light associated with ghosts from reaching the viewing window.

### Improved Eye-Tracking

The inventors have devised an improved user or eye-tracking arrangement. Herein, eye-tracking will be referred to. But it should be understood that the other features of a user may be tracked by the tracking system such that, unless otherwise specified, the terms user-tracking and eye-tracking can be used interchangeably.

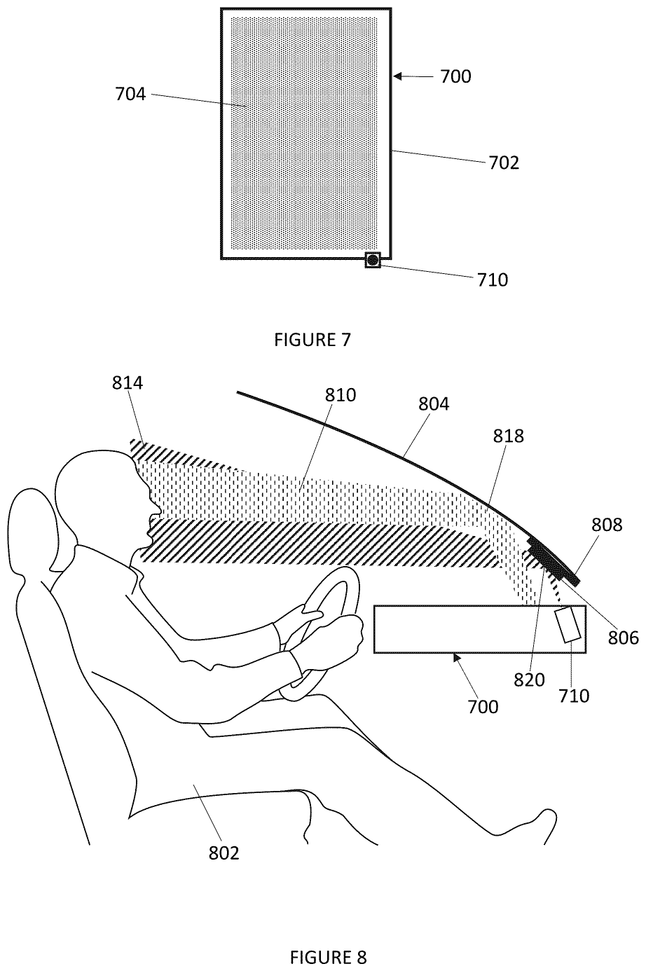

FIG. 7 shows a schematic of a top view of a head-up display package 700 according to the present disclosure. The head-up display comprises a housing 702 and an output port 704. In this example, the output port 704 is formed by a major surface of a waveguide pupil replicator such as the planar second replicator 540 shown in FIG. 5B. For example, the output port 704 may be defined by the partially-reflective, partially-transmissive surface of the planar second replicator 540 from which replicas of a holographic wavefront are emitted. There may be one or more further optical components on top of the partially-reflective partially-transmissive surface which are not shown in FIG. 7. For example, a glare mitigation device and/or turning film may be provided. In any case, the head-up display package 700 is arranged to emit light that has been spatially modulated in accordance with a hologram (i.e. a holographic wavefront) from the output port 704. The spatially modulated light may be visible light (i.e. comprise light having a wavelength in the visible spectrum). In some examples, the spatially modulated light may comprise or consist of light having one or more discrete wavelengths in the visible spectrum. For example, the spatially modulated light may comprise or consist of light at three discrete wavelengths in the visible spectrum: such as red, green and blue light. As the skilled reader will recognise, a full colour image may be reconstructed from three such wavelengths of light when appropriately combined.

The head-up display package 700 further comprises a detector 710. In this example, the detector 710 is an infra-red detector. The infra-red detector 710 is arranged to detect received infra-red light. The head-up display package 700 is arranged to use this detected infra-red light 710 to perform user-tracking (e.g. eye-tracking or gaze-tracking) based on the captured received infra-red light. The inventors have recognised that it is particularly advantageous for the user-tracking equipment (e.g. detector 710) to be provided as part of the head-up display package 700 rather than as a separate stand-alone feature. This is because the output of the tracking (e.g. eye tracking data) can be routed directly to a controller (such as an ASIC) for performing a hologram computation. This means there is low latency such that the controller can respond quickly to changes in a user's position in a viewing window. Furthermore, all the components needed for the head-up display package 700 to operate correctly can advantageously be provided as a single package.

FIG. 8 shows a schematic of the head-up display package 700 in use and in position in the dashboard of a vehicle such as a car. FIG. 8 is a cut-away schematic side view showing a driver 802 seated on a chair of the vehicle holding a steering wheel of the vehicle. The vehicle comprises a windscreen or windshield 804 which may be referred to herein as an optical combiner. The windshield 804 comprises a blackout component 808 on a lower portion of the windshield 804. The size of the blackout component 808 has been slightly exaggerated in FIG. 8. In reality, the blackout component 808 may occupy a relatively very small portion of the bottom of the windshield 804. In particular, the height of the blackout component 808 may be effectively negligible in terms of the field of view of the driver through the windshield. The provision of a relatively narrow blackout component 808 at the bottom of the windshield 804 will, therefore, have a negligible impact on the drivers forward view through the windshield 804. The blackout component 808 may be substantially opaque to visible wavelengths of light. For example, the blackout component may be arranged to absorb at least 90% or more, optionally 95% or more, optionally 99% or more of visible light incident thereon. The blackout component 808 may comprise black paint and/or black ceramic or enamel. The blackout component 808 may be referred to as a frit. The use of black frits around a border of windshields 804 in vehicles is commonplace.

A patch 806 is provided on or adjacent to the blackout component 808. The patch 806 is suitable for reflecting light having a wavelength that is detected by the detector 710. In this example, the detector 710 is an infra-red detector and so the patch 806 is arranged to reflect infra-red light. In other words, the patch 806 has an infra-red reflectively that is greater than that of the rest of the windshield 804. The patch is not visibly intrusive. This is because the patch 806 is provided on the blackout component 808 through which visible light is not transmittable anyway and because the patch 806 may have low reflectance of visible light and because the patch 806 is relatively small. The inventors have recognised that it is advantageous to provide the patch 806 on or adjacent to the blackout component 808 because the blackout component 808 will reduce or eliminate sunlight propagation through the patch (to the detector 710) and so will reduce or eliminate interference. Said interference may be a problem if the patch 806 were instead provided on a visible part of the windshield 804.

FIG. 8 shows how the head-up display package 700 is arranged in cooperation with the windshield 804 to define a first optical path 810 between the head-up display unit to a first viewing region of the display system and a second optical path 814 between the head-up display to a second viewing region of the display system. The first optical path 810 is represented by the vertical dashed or unbroken shading. The second optical path 814 is represented by diagonal shading. The windshield 804 is arranged to direct the visible (spatially modulated) light emitted by output port 704 on the first optical path 810 and to direct the infra-red light received by the detector 710 on the second optical path 814. The first optical path 810 intersects a first portion 818 of the windshield 804 and the second optical path 814 intersects a second portion 820 of the windshield 804. In this example, the first portion 818 does not overlap with the blackout component 808 but the second portion 820 does overlap with the blackout component 808. The second portion 820 overlaps with (or completely falls within) the patch 806. Thus, the second portion 820 of the windshield 804 has an infra-red reflectively that is greater than that of the first portion 818. In this way, infra-red light may travel along the second optical path 814 to be received by the detector 710 and used for user-or eye-tracking.

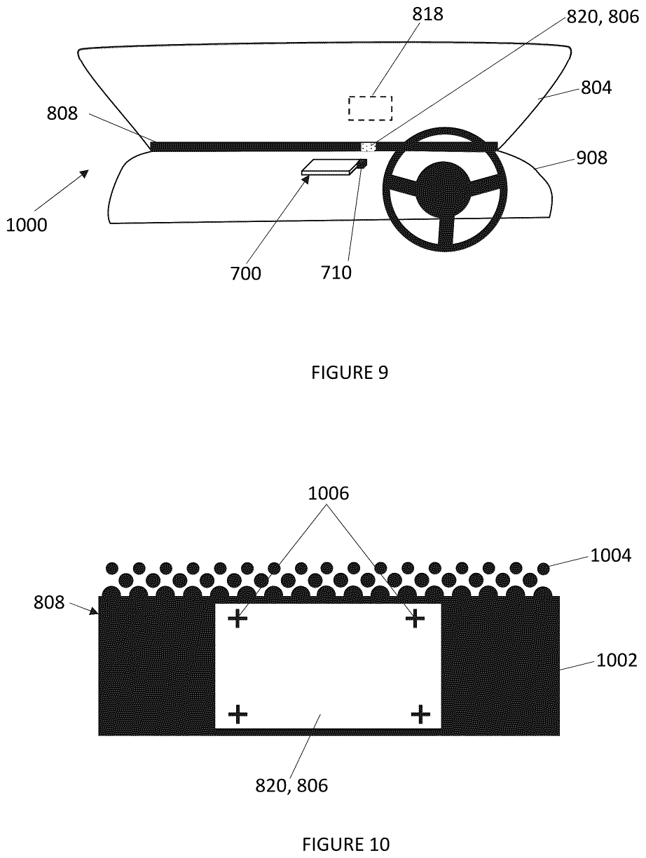

FIG. 9 shows a schematic perspective cut-away view of the inside of the vehicle of FIG. 8, looking towards the windshield 804 (i.e. from the point of view of the driver 802 of FIG. 8). FIG. 9 shows a portion of a dashboard 908 in which the head-up display package 700 (comprising detector 710) is provided. The blackout component 808 (or “frit”) runs along the bottom of the windshield 804. FIG. 9 shows how a portion of blackout component 808 comprises the patch 806 that acts as infra-red reflector. The patch corresponds to the second portion 820, as described above, and is where the second optical path 814 is incident on the windshield 804. The first portion 818 of the windshield 804 (on which the visible light is incident) is represented by the dotted rectangle in FIG. 9. FIG. 9 is schematic. In reality, the first portion 818 may or may not have a rectangular shape, depending on the intended shape of the viewing window/eye-box of the head-up display package 700.

FIG. 10 is a close-up view of a portion of the blackout component 808 and the first portion 818/patch 806. The blackout component 808 comprises a continuous black portion 1002. A top portion 1004 of the blackout component 808 is broken in the form of circles of progressively smaller diameter. The skilled reader will be familiar with frits having such a nature to reduce the contrast between the continuous black portion 1002 and the transparent remaining portion of the windshield 804.

In some examples, displacement or rotation of the patch 806 can cause changes in the effective pointing direction of detector 710. This may be, for example, because of thermal expansion or contraction of the windshield 804. This can be compensated using software correction (and/or physical corrections) of the detector 710. In this example, the patch 806 comprises a plurality of reference markers 1006. The reference markers 1006 in this example are in the form of four crosses. The reference markers 1006 can be tracked such that displacement or rotation of the patch 806/windshield 804 can be monitored and a compensatory change in the pointing error of the detector 710 be determined. Alternatively, reference positions in the vehicle within an image determined by the detector 710 (rather than reference markers on the patch 806).

The blackout component 808 absorbs light. Thus, the blackout component 808 may become hot under illumination from the sun, for example. This may cause high background to the image detected by the detector 710. The inventors have recognised that this high background can be mitigated by providing a thermal insulation layer between the blackout component 808 and the reflector patch 806. Alternatively, the reflector patch can be offset from the blackout component 808 (e.g. the reflector patch 806 may be provided as a free standing component, adjacent to the blackout component). If the reflector patch 806 is provided as a freestanding component, the inventors have recognised that it may be advantageous to provide the patch as a planar component. This may be such that optical distortion from the shape of the windscreen is avoided. If the reflector patch 806 is not planar (e.g. because it conforms to the shape of the windshield 804 which may be curved), then this curvature will need to be compensated for in the pointing angle of the detector 710 and/or processing of the image detector by the detector 710.

The above described example comprises a detector 710 for receiving infra-red light. It should be clear to the skilled person that head-up display package could alternatively or additionally be provided with an infra-red emitter (not shown in the drawings). The infra-red emitter may emit infra-red radiation. The infra-red radiation may be emitted by the emitter along a third optical path which intersects a third portion of the windshield 804. The third portion of the windshield may comprise a patch having an infra-red reflectivity that is higher than the first portion 818. The third portion the windshield may be provided on or adjacent to the blackout component 808. The system may be arranged such that infra-red radiation emitted by the emitter is received at a third viewing region. The third viewing region may be arranged so as to illuminate features of a user, such as the user's face. In some embodiments, the third portion may be the same as the second portion 820. In other words, infra-red light emitted by the emitter and received by the detector 710 may both intersect substantially the same portion on the windshield 804.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. A display system comprising:
an optical combiner; and
a head-up display unit arranged in cooperation with the optical combiner to define: (i) a first optical path between the head-up display unit to a first viewing region of the display system; and (ii) a second optical path between the head-up display unit to a second viewing region of the display system; and
wherein the optical combiner is arranged to direct first light on the first optical path and direct second light on the second optical path, wherein the first optical path intersects a first portion of the optical combiner and the second optical path intersects a second portion of the optical combiner, and wherein the second portion comprises part of a blackout region of the optical combiner.

2. The display system of claim 1, wherein the second portion comprises an infra-red reflective component, optionally wherein the infra-red reflective component has a infra-red reflectivity greater than that of the first portion of the optical combiner.

3. The display system of claim 2, wherein the second portion comprises a thermal insulation layer between the infra-red reflective component and a blackout component.

4. The display system of claim 1, wherein the second portion is disposed below the first portion.

5. The display system of claim 1, wherein the second portion is disposed adjacent a lower boundary of the optical combiner.

6. The display system of claim 1, wherein the first light comprises visible light corresponding to an image visible from the first viewing region, optionally wherein the first light is spatially-modulated in accordance with a hologram of the image.

7. The display system of claim 1, wherein the second light comprises infra-red light for illuminating the second viewing region.

8. The display system of claim 1, wherein the first light is output by a light engine of the head-up display unit.

9. The display system of claim 8, wherein the first optical path corresponds to a field of view of the light engine.

10. The display system of claim 8, wherein the light engine is a picture generating unit or a hologram generating unit.

11. The display system of claim 1, wherein the second light is output by an infra-red light source of the head-up display unit.

12. The display system of claim 1, wherein the head-up display further comprises an infra-red detector arranged to capture second light reflected in the second region, optionally wherein the second light reflected in the second region is reflected by a user of the head-up display, further optionally wherein the infra-red detector performs user-tracking, such as eye-tracking or gaze-tracking, based on the captured second light reflected in the second region, and further optionally wherein the second optical path corresponds to a field of view of the infra-red detector.

13. The display system of claim 1, wherein first viewing region is an eye-box of the display system and second viewing region is a viewer monitoring region of the display system.

14. The display system of claim 1, wherein the first viewing region and second viewing region are the same region of space or at least partially overlapping regions of space.

15. The display system of claim 1, wherein the first viewing region is a sub-region of the second viewing region, or vice versa.

16. The display system of claim 1, wherein the first and second viewing region are each an area of two-dimensional space or volume of three-dimensional space.

17. The display system of claim 1, wherein the second viewing region includes reference positions of a vehicle housing the display system.

18. The display system of claim 1, wherein the second portion comprises reference markers.

19. The display system of claim 1, wherein at least one of (i) the second viewing region includes reference positions of a vehicle housing the display system or (ii) the second portion comprises reference markers; and
wherein the reference positions of the vehicle or the reference markers of the second portion are usable for calibration of the display system such as positional or rotational calibration of an infra-red detector arranged to capture second light reflected in the second region, optionally wherein the second light reflected in the second region is reflected by a user of the head-up display, further optionally wherein the infra-red detector performs user-tracking, such as eye-tracking or gaze-tracking, based on the captured second light reflected in the second region, and further optionally wherein the second optical path corresponds to a field of view of the infra-red detector.

20. The display system of claim 2, wherein the optical combiner has curvature, wherein the infra-red reflective component has curvature or is planar.
